(19) United States
(12) Patent Application Publication
(10) Pub. No.: US 2011/0190007 A1
(43) Pub. Date: Aug. 4, 2011

(54) METHOD AND APPARATUS FOR AUTOMATIC ASSIGNING OF DEVICES

(75) Inventors: Zhigang Chen, Xian (CN); Lei Feng, Shanghai (CN); Daiqin Yang, Shanghai (SG)

(73) Assignee: KONINKLIJKE PHILIPS ELECTRONICS N.V., EINDHOVEN (NL)

(21) Appl. No.: 13/123,986

(22) PCT Filed: Oct. 14, 2009
(86) PCT No.: PCT/IB09/54511

§ 371 Date: Apr. 13, 2011

(30) Foreign Application Priority Data
Oct. 16, 2008 (CN) 200810169990.6

(51) Int. Cl. H04W 24/00

(52) U.S. Cl. 455/456.1

(57) ABSTRACT

In order to solve problems of low accuracy, high computation complexity and low assigning success rate of a topological graph existing on a large scale for device assigning, the present invention proposes methods and apparatuses for automatic assigning of devices. According to an aspect of the present invention, by comparing measured distance-related information between each target device and reference devices, and assumed distance-related information between reference devices and target devices corresponding to assigning nodes, and then selecting the target device with smallest difference to correspond to the assigning nodes, the assigning accuracy of devices is largely improved; according to another aspect of the present invention, based on multiple reference devices, by determining multiple target devices at multiple assigning nodes simultaneously with a large safety margin, assigning complexity is decreased; according to yet another aspect of the present invention, by dividing a large topological graph into blocks and assigning and verifying sub-topology blocks, the assigning accuracy of sub-topology blocks is improved, and error dispersion is avoided, so that the whole assigning success rate of the topological graph is increased.

### TECHNICAL FIELD

The present invention relates to the automatic assigning of devices, particularly to a method and an apparatus for automatic assigning of devices, based on the wireless technology.

### BACKGROUND OF THE INVENTION

Nowadays, device arrays are deployed on a large scale in various buildings and areas, such as arrays constituted by a very large number of illuminating devices, so as to provide multiple functions such as illumination, decoration or display functions. Systems such as a building management system remote monitor and manage the illumination device array, control each illumination device's turn-on, turn-off and switch its illuminating mode, and so on. In order to improve on multiple functions, like illumination, decoration or display, the system must be able to obtain the location of each illumination device accurately, for example, the corresponding relation between the Unique Identification (abbrev. UID) of each device and its installation node position on the design topological graph, so as to send different instructions to all illumination devices at different node positions and thus realize desired illumination, decoration and display functions. If the position of each device obtained by the system is not its real physical position, then this will cause the illumination array not to work properly. The assigning of the device array, performed before normal operation thereof, is for the purpose of solving this problem, so as to make each device correspond to one known node in the topological graph.

Due to the large number of devices in a device array, it is very difficult to carry out manual assigning, and errors may easily occur if doing so. Therefore, the aforesaid assigning work can be performed by making use of the propagation characteristics of radio signals in the air; for example, automatic assigning can be performed by means of the triangulation measurement technology on the basis of the obtained information regarding the distance between the devices. The distance-related information can be obtained through transmission parameters such as Received Signal Strength Indication (abbrev. RSSI) or time of flight of radio signal. By measuring RSSI or time of flight, the distance between two devices can be obtained indirectly so as to carry out the assigning. However, several problems are encountered in the prior art. The first problem is the assigning accuracy of the devices. Since the transmission of radio signals is influenced by many factors, transmission parameters between two devices at the same distance may cause large deviations in different multi-path environments, in the case of different gains of antennas or different interferences, which may cause the distance determined by the transmission parameters to contain large errors, so that the assigning accuracy is affected. The second problem is that, for spaces having two or more dimensions, the determination of positions of all the devices in the whole topological graph based on information about the distance between every two devices proves to be a difficult nondeterministic polynomial

(abbrev. NP) problem. The computation complexity will grow exponentially with the number of devices in the area. The third problem is that, when the number of devices of a device array is very large, the error probability of the assigning in the whole topological graph will increase, and the erroneous assigning will then cause error dispersion, which will lead to more assigning errors.

### SUMMARY OF THE INVENTION

To eliminate the drawbacks of the aforementioned prior art, increasing the accuracy of the device-assigning process, reducing the computation complexity of the assigning and improving the assigning success rate of the whole topological graph are several technical problems in the art that need to be solved. The so-called device comprises the aforesaid illumination devices, and also comprises temperature adjusting devices, audio regeneration devices and so on.

To better address the aforementioned one or more concerns, according to an embodiment of an aspect of the present invention, there is provided a method of determining each target device's position in the topological graph, wherein the method comprises the steps of: a. establishing wireless connections between at least two reference devices and each target device, each of said reference devices' position in the topological graph being known, and said topological graph comprising position information of multiple nodes; b. based on said wireless connections, measuring each target device's measured distance-related information with respect to said at least two reference devices, and obtaining distance reference information; c. based on said distance reference information, determining to which position of said nodes each target device corresponds.

According to a preferred embodiment of one aspect, said step b further comprises the following steps: on the assumption that each target device is at the position of an assigning node in said topological graph, obtaining each target device's assumed distance-related information with respect to said at least two reference devices; corresponding to each target device, said distance reference information comprises the difference between the measured distance-related information and the assumed distance-related information for said assigning node; said step c further comprises: for said assigning node, selecting one target device, from one or more target devices, with a relatively smaller difference between the assumed distance-related information and the measured distance-related information, as the target device corresponding to said assigning node.

According to a preferred embodiment of another aspect, the position of each node in said topological graph being grid-shaped, said step b comprises: enumerating all candidate groups constituted by a predefined number of multiple target devices of said target devices, and determining a mathematical combination of the measured distance-related information of said predefined number of multiple target devices of each candidate group with respect to said at least two reference devices according to a predefined combination rule, and said distance reference information comprises corresponding mathematical combinations of all candidate groups; said step c comprises: c1. based on corresponding mathematical combinations of all candidate groups, selecting one target candidate group according to a predefined rule, and selecting the predefined number of multiple target devices of said target candidate group as selected devices corresponding to a predefined number of multiple assigning nodes neighboring said at least two reference devices; c2. based on said measured distance-related information of predefined multiple selected devices with respect to at least one of said at least two reference devices, determining to which assigning node each of said predefined number of multiple selected devices corresponds respectively.

According to an embodiment of another aspect of the present invention, there is provided a method of determining each target device's position in the topological graph, said topological graph comprising position information of multiple nodes, wherein the method comprises: A. dividing said topological graph into a certain number of sub-topology blocks to be assigned, and determining a reference block, said reference block is adjacent to one or more of said sub-topology blocks to be assigned; B. taking reference devices of said reference block adjacent to said target sub-topology blocks to be assigned as initial reference devices, using an initial assigning method to carry out initial assigning and presuming the presence of (?) said target devices to which each node of said target sub-topology blocks corresponds; C. using verification reference devices different from said initial reference devices and/or a verification assigning method different from said initial assigning method to carry out verification assigning and presuming the presence of (?) said target devices to which each node of said target sub-topology blocks corresponds respectively; D. if the presumption result of said verification assigning is identical to that of said initial assigning, then, judging that said target sub-topology block has been assigned, otherwise judging that said target sub-topology block remains to be assigned; E. taking all of said sub-topology blocks having been assigned as reference blocks and repeating said steps B to D so as to assign all other sub-topology blocks to be assigned.

According to a method or an apparatus associated with one aspect of the present invention, by comparing the measured distance-related information, obtained through actual measurement, with the assumed distance-related information, under the assumption that the device corresponds to assigning nodes, the target devices having the smallest difference between assumed and measured information are selected as corresponding to the assigning nodes, and the assigning has a strong fault tolerance capacity and the assigning accuracy of the devices is substantially improved; according to a method or an apparatus relating to another aspect of the present invention, by determining multiple target devices corresponding to multiple nodes, along with a large safety margin based on multiple reference devices, the computation complexity of the assigning is reduced and the assigning accuracy of the devices is improved; according to a method or an apparatus relating to another aspect, by dividing the topological graph into sub-topology blocks, and assigning and verifying each sub-topology block respectively, the assigning success rate of sub-topology blocks is increased and error dispersion caused by device assigning errors in sub-topology blocks is avoided, so that the assigning success rate of the topological graph is increased.

These and other features of the present invention will be elucidated in detail in the following embodiment part.

### BRIEF DESCRIPTION OF THE DRAWINGS

Features, objects and advantages of the present invention will be more easily understood by means of the following detailed description of non-limiting exemplary embodiments with reference to appended drawings. In the drawings, same or similar reference signs denote same or similar means.

FIG. 1 schematically illustrates the topological graph of an illumination area according to an embodiment of the present invention;

FIG. 2 illustrates a block diagram of the major components in each node and the installed illumination device in the illumination area;

FIG. 3 schematically illustrates the connection between the automatic assigning system and the wireless network via an interface;

FIG. 4 illustrates the flowchart of a method of determining target devices to which the nodes in the topological graph correspond, through the automatic assigning system, according to an embodiment of the present invention;

FIG. 5 schematically illustrates the realization of the apparatus in the form of a computer, according to the present invention;

FIG. 6 schematically illustrates a grid-shaped topological graph according to another embodiment of the present invention;

FIG. 7 schematically illustrates another grid-shaped topological graph according to another embodiment of the present invention;

FIG. 8 illustrates the flowchart of the method of determining target devices to which nodes in the grid-shaped topological graph correspond, through the automatic assigning system, according to another embodiment of the present invention;

FIG. 9 illustrates the process of determining target devices to which all nodes in the grid-shaped topological graph correspond, through the automatic assigning system, according to another embodiment of the present invention;

FIG. 10 schematically illustrates the simulation of the relation between the assigning success rate of the topological graph and the node number of the topological graph;

FIG. 11 schematically illustrates that the automatic assigning system divides the topological graph into several sub-topology blocks, according to another embodiment of the present invention;

FIG. 12 illustrates the flowchart of the method of determining target devices to which nodes in the topological graph correspond, through the automatic assigning system based on sub-topology blocks, according to another embodiment of the present invention.

### DETAILED DESCRIPTION OF THE EMBODIMENTS

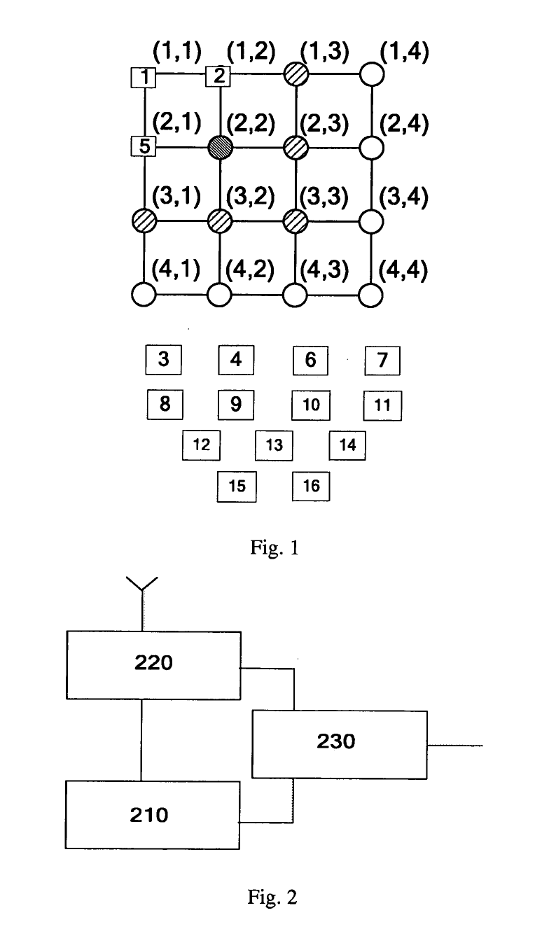

Below, embodiments of the present invention will be elucidated in respect of the system method, with reference to FIG. 1 to FIG. 12. The apparatus and its mode of operation according to the present invention will also be described in the following embodiments.

### First Embodiment

FIG. 1 schematically illustrates an illumination area based on a wireless network, wherein the topological graph of this illumination area is shown, i.e. the positions (1,1), (1,2), . . . (4,4) of each illumination node in the area are all known. There are illumination devices 1, 2, . . . , 16 installed at the nodes in the illumination area, but which illumination device corresponds to which node is unknown. As shown in FIG. 2, each node comprises an illuminating element 210, a wireless communication module 220, such as a ZigBee RF module, and a power supply 230. The wireless communication module 220 can perform wireless communication with wireless communication modules of other nodes, based on the ZigBee RF protocol or other protocols, and establish a wireless network 100. A signal sent by any one of the devices carries the unique identification information of the sending device; the receiving device can determine the sending device of the radio signals, based on the identification information, measure the measured distance-related information, such as RSSI or time of flight of the radio signals and so on, between the present device and the sending device, and provide the measured distance-related information to other nodes or the automatic assigning system 300 outside the wireless network 100. The power supply 230 can comprise elements such as a transformer, and can be connected to a main power supply such as a 120V 60 Hz or a 230V 50 Hz main power supply, so as to provide the electric power needed for the operation of the illumination element and the wireless communication module installed at the node. The illumination area can be in a building or outdoor environment. The purpose of the automatic assigning in the illumination area is to determine to which one of the illumination devices 1, 2, . . . , 16 the nodes (1,1), (1,2), . . . (4,4) respectively correspond. It will be understood that this embodiment uses illumination devices as an example to elucidate the present invention, while the present invention is also applicable to other devices, such as temperature adjustment devices, audio regeneration devices and so on, in topologies of other shapes.

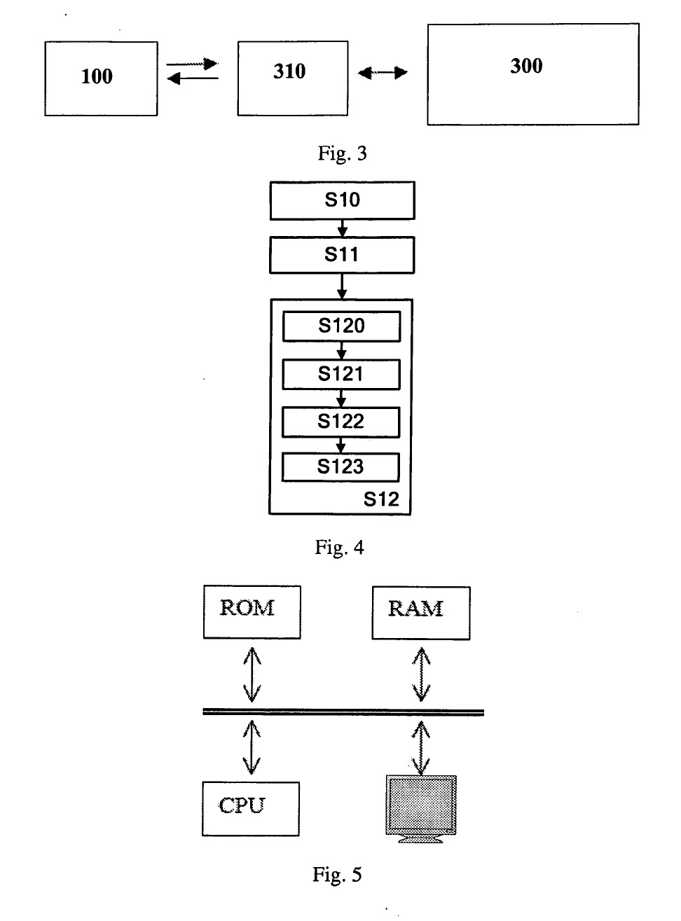

As shown in FIG. 3, the automatic assigning system 300 can be connected with the wireless network 100 via wireless or cable interface 310; for example, the automatic assigning system 300 is connected with one or more illumination devices, to obtain information relating to the distance, such as RSSI or time of flight, among these illumination devices in the wireless network 100.

In this embodiment, in order to determine the nodes where all the target illumination devices are located respectively, firstly, nodes where at least two illumination devices are located should be determined, and then nodes where other devices are located are determined by taking the two illumination devices as reference devices. Like the square shown in FIG. 1, this embodiment takes three reference devices 1, 2 and 5 as an example to elucidate the present invention, and they are at the nodes (1,1), (1,2) and (2,1) respectively. It will be understood that the present invention is also applicable to the case of two reference devices or more than three reference devices. The position determination of the reference devices can be performed by using existing manual input when the devices are installed, or by other methods. After the reference devices are determined, this embodiment firstly determines which illumination device is installed at the node (2,2), which is represented by means of a dark color. In this embodiment, reference devices are re-used as illumination devices; it will be understood that reference devices can also be devices which are used specifically for assigning.

As shown in FIG. 4, in step S10, illumination devices (including reference devices) in the topological graph should establish a wireless network 100 among them, and establish wireless connections between each of the three reference devices and each illumination device. It should be noted that the “wireless connection” mentioned in the present invention doesn't require a connection-oriented or connectionless point-to-point communication link to be established between every two devices, but refers to a device being capable of detecting radio signals sent by another device so as to obtain necessary information such as RSSI and/or time of flight, based on the received signals. For example, this can be done by establishing a wireless connection through a network searching process, which is done when any of the illumination devices and its wireless communication device start up. For example, the wireless communication module of each illumination device is adjusted to a broadcast channel and broadcasts a bulletin message comprising the type of the present device, and requiring all other devices to reply and identify the source; after each illumination device has received the bulletin message from other devices, distance-related information, such as RSSI or time of flight of radio signals, between the present device and the sending device can be determined. Furthermore, a device can monitor whether there is a bulletin message from other devices, without sending a bulletin message actively, and obtain necessary information from the received bulletin message, i.e. the “wireless connection” can also be one-directional. In this embodiment, each of the three reference devices 1, 2 and 5 obtains the actual RSSI_{ref}_{ᵢ}_{, device}_{ⱼ} between it and neighboring target illumination devices respectively, and provides the actual RSSI_{ref}_{ᵢ}_{, device}_{ⱼ} to the automatic assigning system 300, wherein, refᵢ, iε{1, 2, 5} represents each reference device, deviceⱼ, jε{3, 4, 6, . . . , 16} represents each target illumination device. If a target illumination device is far from the reference devices, then signals it sends may not be detected by the reference devices, thus the RSSI between it and the reference devices can be neglected or considered as infinitesimal. Most of the commercial RF chips and modules can support the function of obtaining RSSI for reference devices, and its concrete use is not the focus of the present invention and thus will not be described further.

It will be understood that propagation attenuation of radio signals generally satisfies the following formula:

RSSI(dB)=10lgC−λ10lgd (1),

wherein C is the coefficient related to the antenna gains and the frequency etc., λ is the path loss factor, and d is the distance between the sending device and the receiving device. As can be seen, the change tendency of RSSI is contrary to that of the distance. In a practical environment, RSSI may be influenced by other factors. Therefore, in order to determine a few illumination devices at a few nodes, the measurement results of more target illumination devices can be taken into consideration, in order to avoid the omission of target devices caused by RSSI measurement errors. In this embodiment, in order to determine an illumination device installed at the assigning node (2,2), the wireless network 100 can measure and obtain the measured RSSI (can be an upstream RSSI from target devices to reference devices, or a downstream RSSI from reference devices to target devices, or the mean of upstream and downstream RSSI) of six illumination devices with larger RSSI with respect to the three reference devices 1, 2 and 5, and provide the measured RSSI to the automatic assigning system 300, so as to reduce computations considerably; the wireless network 100 can also provide the measured RSSI from all 13 target devices to the reference devices to the automatic assigning system.

Then, in step S11, the automatic assigning system 300 receives the measured RSSI between each target device of the wireless network 100 and each of the three reference devices 1, 2 and 5. The system 300 also assumed that each target illumination device was located at the assigning node (2,2). The relative assumed RSSI of each target illumination device with respect to three reference devices 1, 2 and 5 at the reference positions is calculated respectively under the assumed condition, wherein the relative assumed RSSI is denoted by RSSI_{ref}_{ₜ}_{, pos}−RSSI_{ref}_{₁}_{, pos}, refᵢ, iε{1,2,5} represents each reference device, pos represents the assigning node (2,2).

The automatic assigning system 300 employs the relative RSSI vector as the norm to describe the RSSI between target devices and reference devices 1, 2 and 5. For the assigning node (2,2) the assumed RSSI vector is defined as corresponding to the following formula:

V_assumed=(0,

RSSI_{ref}_{₂}_{,pos}−RSSI_{ref}_{₁}_{,pos},

[symbol]

(2)

As can be known from formula (1), the vector element RSSI_{ref}_{₂}_{, pos}−RSSI_{ref}_{₁}_{, pos} only depends on the ratio of the distance between the assigning node and the reference device 2 to the distance between the assigning node and the reference device 1, and the path loss factor λ, while parameter C including the antenna gains and so on can be counteracted. Since the node position of the assigning node and each reference device are known in the topological graph, the distance ratio can be easily obtained, and the path loss factor λ can also be obtained by simple measurement in the practical environment, hence the relative assumed RSSI can be obtained through calculation.

The relative measured RSSI is defined as corresponding to the following formula:

V_measured(deviceⱼ)=(0,

RSSI_{ref}_{₂}_{,device}_{ⱼ}−RSSI_{ref}_{₁},device_{ⱼ},

[symbol]

(3)

It will be understood that RSSI_{ref}_{₁}device_{ⱼ} and RSSI_{ref}_{ₛ}_{,device}_{ⱼ} are the measured RSSI of each target device with respect to each of the reference devices 1, 2 and 5 respectively, and the automatic assigning system 300 has obtained these data, hence the relative assumed RSSI can also be obtained through calculation.

Then, the automatic assigning system 300 calculates the difference between the relative measured RSSI vector of each target device and the relative assumed RSSI vector thereof with respect to the assigning node (2,2), wherein the difference is used as the distance reference information of each target device. Concretely, the difference of the vectors can be the mode of the vector difference, and can also be calculated by the following formula:

$${d}_{{device}_{j}} = {\sum }_{n = 1}^{3} {( V\_measured {( {device}_{j} )}_{n} - {V\_assumed}_{n} )}^{2} , \qquad ( 4 )$$

wherein, V_measured(deviceⱼ)ₙ and V_assumedₙ represent the nth element of the relative measured RSSI vector and the nth element of the relative assumed RSSI vector, respectively.

After that, in step S12, for the assigning node (2,2), the automatic assigning system 300 compares of each target device the calculated difference between its relative measured RSSI vector and the relative assumed RSSI vector thereof with respect to the assigning node (2,2), so as to determine the target illumination device corresponding to the assigning node (2,2). This is similar to the maximum likelihood sequence detection, such as the Viterbi Decoding Algorithm. It will be understood that the aforesaid formula (4) is only used as an example, i.e. those skilled in the art can modify it by setting weighted coefficients and so on, so as to adapt it to the practical network environment.

In one case, in order to reduce computations, the automatic assigning system 300 selects the target illumination device having the smallest difference between its assumed value and its measured value as the illumination device at the assigning node (2,2).

Above, the present invention is elucidated by taking relative RSSI as an example. In this case, the relative assumed RSSI vector can be determined by the ratio of the distances between assigning node and each reference position. It will be understood that the use of the relative RSSI is for the purpose of simplifying the measurement of the wireless communication environment in the topological graph and at the same time eliminating the antenna gain difference of wireless communication modules of illumination devices. According to the teaching of the embodiment, those skilled in the art will know that the present invention can be based on the comparison between the absolute assumed RSSI of the distance between assigning nodes and each reference position and the absolute measured RSSI thereof. According to formula (1), the system 300 obtains parameter C of each illumination device, including its antenna gain, so as to determine the absolute assumed RSSI between the illumination device and each reference device under the assumption that the illumination device is at the assigning node, compares the absolute assumed RSSI with the absolute measured RSSI and selects the target device having the smallest difference between the assumed value and the measured value as the illumination device at the assigning node (2,2), so that the measurement distortion caused by the change of the propagation characteristics can be maximally reduced.

In another case, in order to ensure the correctness of the selection, in step S120, the automatic assigning system 300 takes multiple target devices having a smaller difference between the assumed value and the measured value as candidate illumination devices corresponding to the assigning node (2,2), and then verifies each candidate illumination device so as to determine which illumination device is most likely to be located at the assigning node (2,2).

Concretely, in step S121, the automatic assigning system 300 takes the multiple candidate illumination devices as the first auxiliary reference device, which is used together with the reference device 1, 2 and 5 to presume auxiliary target devices correspond to multiple auxiliary reference nodes nearby. In order to facilitate the description, in the present invention, k_{can} represents the number of multiple candidate illumination devices, k_{ref} represents the number of auxiliary reference nodes. The automatic assigning system 300 can select a suitable number k_{can} of candidate illumination devices, and suitable auxiliary reference nodes and their number k_{ref} according to the scale of the topology and the computational capacity of the system. As shown in FIG. 1, in this embodiment, the automatic assigning system 300 selects five nodes, namely (1,3), (2,3), (3, 1), (3, 2) and (3,3), which are closest to the reference devices 1, 2, 5 and the assigning node (2,2), as the auxiliary reference nodes indicated with left-down oblique lines in FIG. 1. Then, based on each of k_{can} first auxiliary reference devices and the reference devices 1, 2 and 5, the automatic assigning system 300 employs certain assigning methods to presume presence of (?) auxiliary target devices at the five auxiliary reference nodes (1,3), (2,3), (3, 1), (3, 2) and (3, 3) respectively. The system 300 can employ the existing assigning method based on reference devices, and can also use the maximum likelihood method similar to the foregoing steps S10 to S12, which is used to determine the installed illumination target device at the assigning node (2,2). Concretely, in step S1210, the system 300 obtains the measured RSSI from each target illumination device to each reference device as well as each first auxiliary reference device. In step S1211, it is assumed that each target device is located at each auxiliary reference node, and there is calculated the assumed RSSI between each target device and each reference device as well as each first auxiliary reference device, under this assumption. And finally in step S1212, based on the comparison of the measured RSSI with the assumed RSSI, it is presumed that the target devices have a smaller difference at auxiliary reference nodes. It will be understood that the order of the foregoing steps S1210 and step S1211 is not definite. Likewise, it can also be presumed that there are one or more auxiliary target devices for each auxiliary reference node, for example, if it is presumed that there are k_{can} auxiliary target devices for each auxiliary reference node, then for k_{can} candidate illumination devices there is a total of k_{can}⁶ combinations of candidate illumination devices and auxiliary target devices, which means the combinations correspond to 1 assigning node and 5 auxiliary reference positions, and there are k_{can} possible devices for each position.

Then, by using the method similar to the aforesaid steps S10 to S12 for determining the assigning node (2,2), in step S122, the automatic assigning system 300 takes the positions of the reference devices 1, 2 and 5 and five auxiliary reference nodes (1,3), (2,3), (3,1), (3,2), (3,3) as reference positions. For k_{can}⁶ combinations of candidate illumination devices and auxiliary target devices, the automatic assigning system 300 obtains the measured RSSI of corresponding candidate illumination devices with respect to reference devices 1, 2, 5 and corresponding auxiliary target devices for each combination, and a total of k_{can}⁶ measured RSSI corresponding to k_{can}⁶ combinations should be obtained. For k_{can}⁶ combinations of candidate illumination devices and auxiliary target devices, the automatic assigning system 300 obtains also the assumed RSSI of each candidate illumination device with respect to the reference devices 1, 2 and 5 and corresponding auxiliary target devices, under the assumption that each candidate illumination device is located at the assigning node (2,2), and a total of k_{can}⁶ assumed RSSI corresponding to k_{can}⁶ combinations should be obtained. The assumed RSSI can be a relative RSSI or an absolute RSSI.

Finally, in step S123, the automatic assigning system 300 determines the combination having the smallest difference between the measured RSSI and the corresponding assumed RSSI of candidate target devices, among k_{can}⁶ combinations, and selects the candidate target device in this combination at the assigning node (2,2) as the target device at this node. The concrete comparison method can be based on relative RSSI or absolute RSSI and will not be described further. Compared with the aforesaid method in which no verification is performed, the present method presumes the presence of (?) multiple candidate target devices, and performs a comparative verification of their likelihood based on methods like the maximum likelihood, and determines the illumination device which is most likely to be located at the assigning node (2,2), so that the success rate of the assigning is increased.

Preferably, after the illumination device corresponding to the assigning node has been determined, the illumination device can be taken as a reference device together with the reference devices 1, 2 and 5. The system 300 repeats the above steps S10 to S12, determines whether illumination devices are installed at other assigning nodes, until all the target devices corresponding to all the assigning nodes in the topological graph are determined, and then the assigning process of the topological graph is completed. It will be understood that, in the assigning process of assigning nodes, the more reference devices the assigning is based on, the higher the accuracy of the assigning should be. The automatic assigning system should select reference nodes at suitable positions according to the practical scale of the topological graph and the computation capacity of the system, which not only ensures the accuracy of the assigning but also substantially reduces the computational load involved in assigning.

Above, the present invention is described by taking RSSI as an example; it should however be understood that the present invention can also be used for comparison of other distance-related information, for example, the difference between the actually measured time of flight and the assumed time of flight, under the assumption that illumination devices are located at assigning nodes, and the system then determines the illumination devices installed at each assigning node, based on the difference. Furthermore, RSSI can also be employed together with time of flight. Based on the teachings of the present invention, those skilled in the art can obviously devise other methods, according to the present invention, based on the comparison of the difference between the assumed and measured other distance-related information, which methods are also within the scope of the appended claims of the present invention, and hence the specification will not give further details herein.

Similar to the aforementioned method, in one aspect of the present invention, the automatic assigning system 300 can comprise corresponding means to fulfill the function of each step. Concretely, it comprises a receiver configured to communicate with the wireless network 100, i.e. the receiver can communicate with one or more devices in the wireless network 100 via a wireless or cable interface, and obtain measured distance-related information such as RSSI from among the devices; a receiver and a first obtaining means configured to fulfill step S11, a candidate illumination determining means configured to fulfill step S120, an auxiliary target device presuming the presence of (?) means configured to fulfill step S121, a second obtaining device configured to fulfill step S122 and a first determining means configured to fulfill step S123. Preferably, the auxiliary target device presuming the presence of (?) means can also comprise a third obtaining means configured to fulfill step S1210, a fourth obtaining means configured to fulfill step S1211 and a second determining means configured to fulfill step S1212. As shown in FIG. 5, the first obtaining means and the first determining means as well as its sub-means can be integrated in a computer, and realized in the form of a CPU, which is programmed to fulfill corresponding functions. The function programs can be read by CPU from memories such as ROM or RAM, and the assigning result can be displayed on the monitor for viewing by the assigning operator. The receiver can communicate with the first obtaining means and the first determining means via serial interface or Ethernet interface. It will be understood that the structure of the automatic assigning system 300 is not limited to the embodiment, and based on the above detailed description, those skilled in the art can design corresponding means and an associated operating process, which are also within the scope of the appended claims of the present invention: therefore the specification will not give further details herein.

It can be understood that an aspect of the present invention according to the above embodiment is not limited to the two-dimensional grid-shaped topological graph shown in FIG. 1; it is also applicable for arbitrary shapes and arbitrary dimensions, such as in a three-dimensional topological graph. These are also within the scope of the appended claims of the present invention and in the specification no further details will be given.

Hereinabove, according to an aspect of the present invention, a method and apparatus have been elucidated in detail, namely an automatic assigning system compares the measured distance-related information between each target device and reference devices with the assumed distance-related information between each target device and reference devices with respect to one assigning node, and selects the target device having the smallest difference as the target device. Below, an assigning method according to another aspect of the present invention will be elucidated.

### Second Embodiment

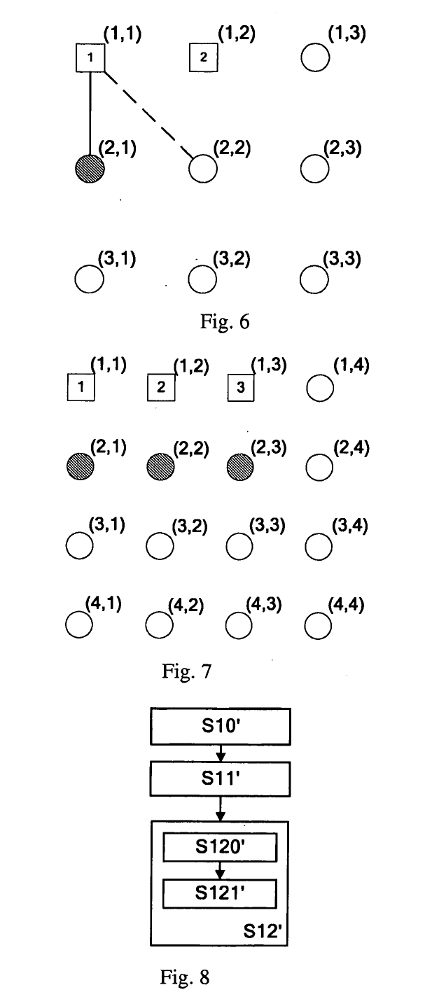

Before the embodiment according to another aspect of the present invention is described, related knowledge about the safety margin of the assigning will be introduced first. As shown in FIG. 6, in the topological graph where nodes are distributed in a square grid shape, the reference devices 1 and 2 are placed at the reference node (1,1) and (1,2) respectively; other unknown target illuminating devices are placed at other nodes, and the configurations of the wireless communication modules of each illumination device are identical (for example, antenna gains and transmitting power are identical). When the assigning node (2,1) closest to the node (1,1) is assigned, since the distance between the node (2,1) and the node (1,1) is the smallest one of the distances between the node (1,1) and each of all nodes (except for the reference node (1,2)), the assigning can be based on the following principle: among all target devices, the illumination device having the largest RSSI between it and the reference device 1 is the illumination device at the assigning node (2,1). Meanwhile, since the target illumination device at the node (2,2) is the second closest to the position (1,1), this target illumination device is most likely to be mistaken as the one at the assigning node. Theoretically, the RSSI between the target illumination device at the node (2,2) and the reference device 1 is 10lgC−10λlg\sqrt{2}d, wherein C is a constant related to antenna gain, frequency etc., λ is the path loss factor, and d is the side length of the square grid, while the RSSI between the target illumination device at the assigning node (2,1) and the reference device 1 is 10lgC−10λlgd, the former is smaller than the latter by m=10 λlg\sqrt{2} dB, and the value of m is the safety margin in this assigning method. If due to the influence of the practical environment, the actually measured RSSI between the target illumination device at the node (2,2) and the reference device 1 is equal to or bigger than the RSSI between the target illumination device at the assigning device (2,1) and the reference device 1, the assigning system will have difficulty judging the target device corresponding to the assigning node (2,1), and may even wrongly determine the illumination device at the node (2,2) to be the one at the node (2,1). Therefore, the safety margin should be generally as large as possible in order to avoid incorrect assigning.

While assigning two target devices at the closest two assigning nodes (2,1) and (2,2) simultaneously, based on the two reference devices 1 and 2, the assigning is, for example, based on the following principle: the sum of five RSSI, i.e. one is the RSSI between the two target devices at the two assigning nodes and the other four are the RSSI between each of the two target devices and each of the two reference devices respectively, that is the largest. By enumerating and calculating all combinations of two target illumination devices of all target illumination devices, the system selects two target devices, with the largest combination, as being at the assigning nodes (2,1) and (2,2). Meanwhile, the two illumination devices at the illumination positions (2,2) and (1,3) are the second closest to the reference devices. Likewise, it can be obtained by calculation that the sum of its five RSSI, i.e. one is the RSSI between the two illumination devices at the two illumination positions (2,2) and (1,3) and the other four are the RSSI between each of the two illumination devices and each of the two reference devices respectively, is smaller than the sum of the five RSSI corresponding to the two illumination devices at the assigning nodes (2,1) and (2,2) by m′=10λlg2 dB. As can be seen, the safety margin of the assigning method is improved as compared with the safety margin m=10λlg\sqrt{2} dB of the aforesaid method, in which one reference device is used to assign one target illumination device.

According to another aspect of the present invention, the safety margin is improved, after measuring the measured distance-related information between each target device and reference devices respectively, by (?) enumerating all candidate groups constituted by a predefined number of multiple target devices of all target devices, determining for all said candidate groups a mathematical combination of the measured distance-related information of the predefined number of multiple target devices with respect to said at least two reference devices according to a predefined combination rule, selecting one target candidate group according to a predefined rule, selecting a predefined number of multiple target devices of the target candidate group as selected devices corresponding to a predefined number of multiple assigning nodes adjacent to reference devices, and then determining assigning nodes corresponding to each selected device, based on the measured distance-related information between each selected device and reference devices respectively.

Below, this aspect of the present invention will be elucidated through an embodiment. As shown in FIG. 7, in the topological graph, the node positions (1,1), (1,2) and (1,3) are reference positions. It is known that reference devices 1, 2 and 3 are at these positions; illumination devices installed at other nodes are unknown target illumination devices to be assigned. The three reference devices are on the same grid line and adjacent to each other, and each target device is located on the same side of the three reference devices or on the same grid line as the three reference devices, for example, the reference devices in the Figure are located in the left upper corner of the whole topological graph, and target illumination devices are located on the right and on the lower side of the reference devices. The order of the assigning also satisfies the above condition, namely from top to bottom and from left to right, so as to guarantee that target illumination devices are located on the right or on the lower side of the assigned devices. The embodiment first assigns the three assigning nodes (2,1), (2,2) and (2,3) adjacent to the three reference positions on the same side respectively.

As shown in FIG. 8, first, in step S10′, each illumination device and reference devices in the topological graph should establish the wireless network 100. The determination method of reference devices and the establishment method of the wireless network 100 are similar to those in the aforesaid first embodiment, hence no further descriptions will be given herein.

Then, in step S11′, the automatic assigning system 300 can obtain the actual RSSI from each of the target illumination devices to each of the three reference devices 1, 2 and 3, based on the wireless network 100. Suppose RSSIᵢ^{j} represents the measured RSSI between the reference position j and the assigning node i. Then, for each assigning node, defining parameter Dᵢ=RSSIᵢ¹−RSSIᵢ³, this parameter is related to the ratio of the distance between the assigning node i and the reference device 1 and the distance between the assigning node i and the reference device 3.

According to the grid structure shown in FIG. 7, for each assigning node i, the parameter Dᵢ should satisfy:

D_{(1,1)}>D_{(3,1)}<D_{(3,2)}=D_{(2,2)}< (5)

And, as is clear from the grid-shaped topological graph shown in FIG. 7, the sum of the distances between the assigning nodes (2,1) and (2,2) and the reference positions (1,1) and (1,2) is the smallest; the sum of the distances can be represented in the form of the sum of RSSI between the target illumination devices and the reference devices 1 and 2.

In compliance with the above two principles, based on the RSSI between each target illumination device and the reference devices 1, 2 and 3, the automatic assigning system 300 respectively combines the RSSI between each target illumination device and each of the reference devices 1, 2 and 3 according to the linear combination rule described by the following formula:

A_{device}=RSSI_{device}¹+RSSI_{device}²−0.5×RSSI_{device}³ (6).

wherein the variable device represents each target illumination device, RSSI_{device}^{r},r=1, 2, 3 represents the RSSI between the target illumination device and the reference device r

Then, in step S120′, the automatic assigning system 300 compares the value A of all target illumination devices and selects the two target illumination devices having the largest and the second largest value A, respectively, as the selected devices corresponding to the assigning nodes (2,1) and (2,2). In order to ensure the correctness of the order, the nodes where the two selected devices are located respectively remain(?) unknown and will be determined in successive steps.

Then, based on the two selected devices, the third selected device at the assigning node (2,3) is presumed from remaining target illumination devices. According to the grid-shaped topological graph shown in FIG. 7, the sum of the distances between the third selected device and each of the reference devices 2 and 3 as well as the device at the node (2,2) should be the smallest, likewise, the sum of the distances can also be represented by RSSI. Since it is currently unknown which one of the first two selected devices is installed at the position (2,2), the embodiment considers the target illumination device which is closer to the first two selected devices. Then, based on the RSSI between each target illumination device and each of the reference devices 2 and 3, and the relatively large RSSI between each target illumination device and each of the first two selected devices, the automatic assigning system 300 performs a combination according to the linear combination rule described by the following formula:

B_{device}=RSSI_{device}²+RSSI_{device}³+RSSI_{device}^{L} (7),

wherein, the variable device represents each remaining target illumination device, RSSI_{device}^{L} is the relatively large one of the two RSSI between the target illumination device and each of the first two selected devices.

Then, the automatic assigning system 300 compares the value B of all remaining target illumination devices, and selects the target illumination device having the largest value B as the third selected device.

The above mentioned linear combination formula (6) and (7), for determining three selected devices, are heuristic algorithm formulas based on the grid-shaped topological graph. Those skilled in the art will understand that the present invention is not limited to the above formulas; through algorithm design, other methods and formulas used to determine three selected devices corresponding to three assigning nodes can be designed, such as another example shown below.

As shown in FIG. 7, based on the two reference positions (1,1) and (1,2), all combinations constituted by two of the target illumination devices are enumerated, and two illumination devices in a combination whose sum of five RSSI, i.e. one is the RSSI between the two illumination devices and the other four are the RSSI between the two illumination devices and the two reference devices 1 and 2 respectively, is the largest, are at the assigning nodes (2,1) and (2,2) adjacent to the two reference positions (1,1) and (1,2). And then, based on the two reference positions (1,2) and (1,3), selected devices at the assigning nodes (2,2) and (2,3) are determined in the same way. The two assigning nodes (?) should obtain three different selected devices and the three selected devices should be at these three (?) assigning nodes.

After determining three selected devices at three assigning nodes, in step S122′, the automatic assigning system 300 determines the assigning nodes where the three selected devices are respectively located, based on the distance-related information between the three selected devices and the three reference devices.

Concretely, according to the grid topological graph such as shown in FIG. 7, for the three selected devices at (2,1), (2,2) and (2,3), they should meet the following conditions:

1. Let variable Cᵢ=RSSIᵢ¹−RSSIᵢ³ be the difference between the RSSI from the selected device which should be at the assigning point i to the reference device 1 and the RSSI from the aforesaid selected device to the reference device 3, for the three assigning nodes, the variable Cᵢ should satisfy the following relations:

C_{(2,1)}>C_{(2,2)}>C_{(2,3)} (8)

|C_{(2,2)}|<C_{(2,1)}|=C_{(2,3)}| (9)

2. The sum of the RSSI from the selected device at the middle position (2,2) to two other selected devices should be the largest; suppose RSSI_{i,j} is the RSSI from the selected device at the assigning node i to the selected device at the assigning node j, and variable

$${E}_{i} = {\sum }_{j = ( 1 , 1 ) , ( 1 , 2 ) , ( 1 , 3 )}^{j \neq i} {RSSI}_{i , j} ,$$

with the following relation:

E_{(2,2)}>E_{(2,1)}=E_{(2,3)} (10)

Based on the above two conditions, by first comparing the difference (corresponding to value Cᵢ) between the RSSI from the selected device to the reference device 1 and the RSSI from the selected device to the reference device 3, the three selected devices are determined at the assigning nodes (2,1), (2,2) and (2,3) according to the order of the difference from large to small. In order to further improve the accuracy of the assigning, the selected device at the middle position (2,2) will be verified again. The difference (corresponding to Eᵢ−|Cᵢ|) between the sum (corresponding to value Eᵢ) of the RSSI from the selected device at the middle position to the other two selected devices and the absolute value of the difference (corresponding to value Cᵢ) between the RSSI from the selected device at the middle position to the reference device 1 and to the reference device 3 should be the largest. If the selected device with the largest difference is not located at the middle position after verification, then it should be exchanged with the selected device currently at the middle position.

It will be understood that the above method and the formulas (8), (9) and (10) for determining assigning nodes where three selected devices are located respectively, are not unique, but are heuristic algorithm formulas based on the grid-shaped topological graph. Through algorithm design, those skilled in the art can design other methods and formulas for determining assigning nodes where selected devices are located respectively, for example, weighting RSSI or performing non-linear combinations and so on, which are also within the protective scope of the present invention.

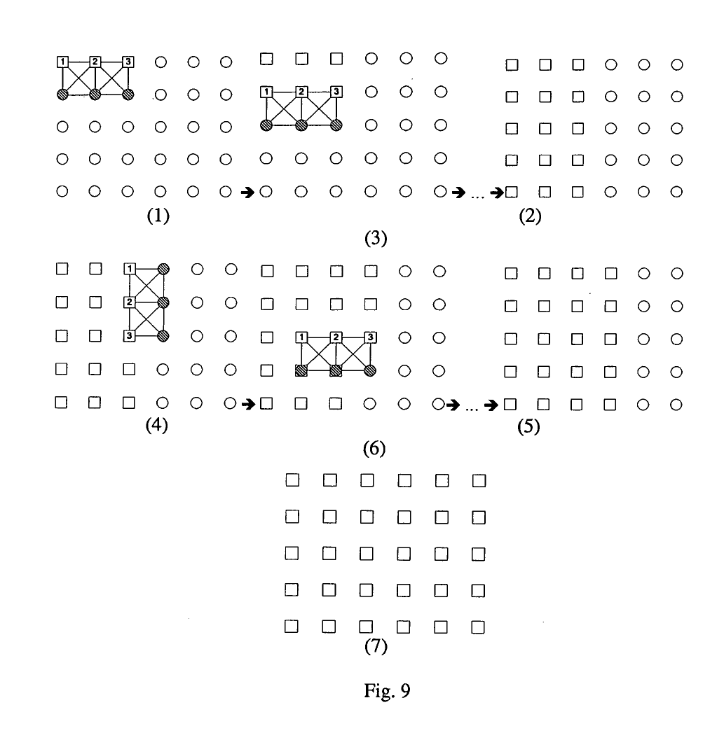

After determining three selected devices respectively at the assigning nodes (2,1), (2,2) and (2,3), the automatic assigning system 300 takes the three selected devices at the nodes (2,1), (2,2) and (2,3) as new reference devices, and assigns other target illumination devices adjacent to the nodes (2,1), (2,2) and (2,3). As shown in FIG. 9, wherein square blocks represent assigned nodes and devices, hollow circle blocks represent nodes to be assigned, circle blocks in dark color represent nodes being commissioned. As shown in FIG. 9 (3), the automatic assigning system determines illumination devices installed at all nodes in the left part of the topological graph. Then, as shown in FIG. 9 (4), the automatic assigning system can take three neighboring assigned illumination devices in a vertical line as reference devices, and determines target illumination devices installed at three neighboring assigning nodes in a vertical line on the right side of the reference devices. And, as shown in FIG. 9 (5), assigned selected devices can be verified in order to improve the accuracy of the assigning. Finally, illumination devices installed at all nodes in the whole topological graph are determined and the assigning process is finished.

Above, RSSI is taken as an example to elucidate the present invention, however, it will be understood that the present invention can also use other distance-related information, such as time of flight or a combination of time of flight and RSSI. According to the teachings of the present invention about RSSI, those skilled in the art can obviously find methods of determining multiple devices based on multiple reference devices, which are also within the scope of the appended claims of the present invention, and about which the specification will not give further details herein.

The automatic assigning system 300 can comprise corresponding means configured to fulfill the function of each step respectively, for example a receiver and a first obtaining means configured to fulfill step S11′, a candidate group determining means configured to fulfill step S120′ and a third determining means configured to fulfill step S121′. These means can be realized through a programmed CPU, which is similar to that shown in FIG. 5. Based on the aforementioned description, those skilled in the art can design and realize corresponding means and their mode of operation, which is also within the scope of the appended claims of the present invention, and thus the specification will not give further details herein.

It will be understood that an aspect of the present invention according to the above embodiment is not limited to the two-dimensional grid-shaped topological graph shown in FIG. 6, FIG. 7 and FIG. 9, but is also applicable for other grid-shaped topological graphs and a three-dimensional environment. These are all within the scope of the appended claims of the present invention, and thus the specification will not give further details herein.

Above, according to an aspect of the present invention, a method and apparatus have been elucidated, namely the automatic assigning system that determines multiple illumination devices at multiple target nodes simultaneously with a large safety margin, based on multiple reference devices, and that then determines target nodes where the multiple illumination devices are located respectively. Below, an assigning method according to another aspect of the present invention will be described in detail.

### Third Embodiment

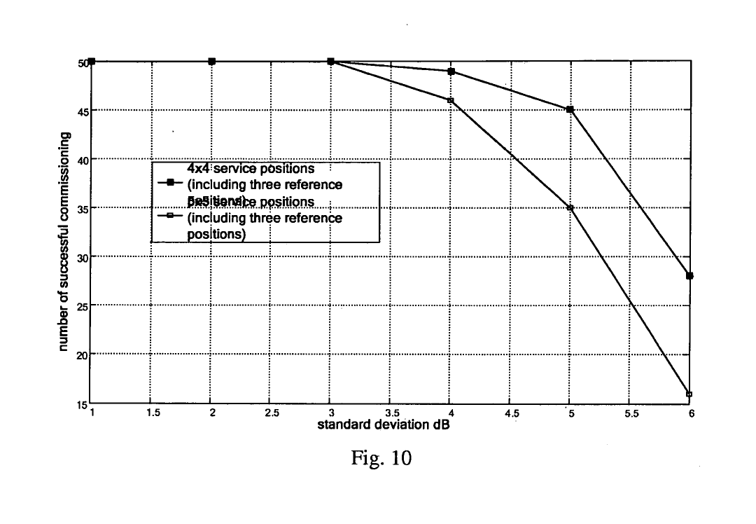

The assigning success rate of the whole topological graph is related to the node number of the topological graph. As shown in FIG. 10, the simulation result illustrates the relation between the number of successful assigning operations and the node number of the topological graph; its vertical coordinate represents how many out of fiftyassigning operations are successful, the horizontal coordinate represents the standard deviation of measurement errors of RSSI (assume that the measurement error of RSSI is zero mean Gaussian distributed). The assigning method employed by the simulation is the method used in the aforesaid first embodiment. As can be seen, with the increase of nodes from sixteen to twenty-five (each comprises three reference nodes), the number of successful assigning operations is decreased. The reason is that the more nodes there are, the more likely wrong assigning will occur for the plurality of nodes on the whole. Meanwhile, wrongly assigned nodes may be taken as reference nodes to assign other nodes and then disperse errors. Therefore, in order to assign a large topological graph correctly, engineering staff may need to perform assigning operations a number of times.

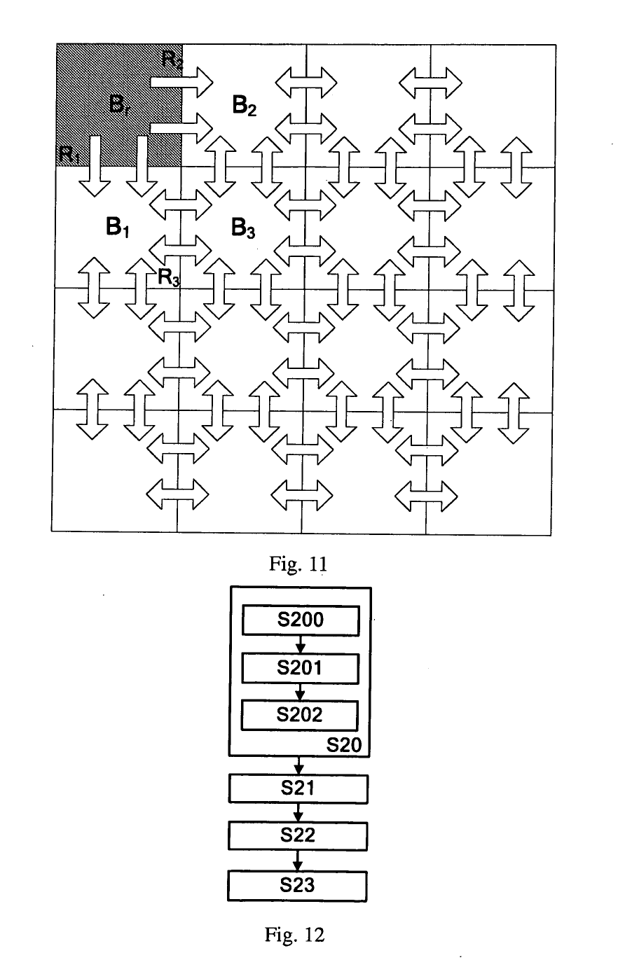

In order to solve this problem, according to another aspect of the present invention, as shown in FIG. 11, the automatic assigning system 300 divides a large topological graph into multiple sub-topology blocks. The system 300 assigns sub-topology blocks, based on reference devices, and verifies each sub-topology block. Only those devices in sub-topology blocks which prove to be assigned correctly after verification, can be taken as reference devices to assign other sub-topology blocks, so that error dispersion is avoided; it is also allowed that sub-topology blocks wrongly assigned can be assigned several times to achieve a correct assigning, so as to improve the assigning success rate of the whole topological graph.

Concretely, as shown in FIG. 12, in step S20, the automatic assigning system 300 divides the topological graph into a certain number of sub-topology blocks to be assigned according to a predefined rule. Preferably, the certain number of sub-topology blocks to be assigned do not omit nodes and target devices of the topological graph, and these sub-topology blocks are also not overlapped; for example, as shown in FIG. 11, the topological graph is divided evenly into sixteen sub-topology blocks adjacent to each other in the form of a grid. The concrete method of dividing sub-topology blocks is not the focus of the present invention, and those skilled in the art can determine satisfactory ways of dividing according to practical requirements.

In step S20, the automatic assigning system 300 further determines a reference block Bᵣ. The reference block is adjacent to the sub-topology blocks B₁ and B₂ to be assigned, as shown at the top left corner of FIG. 11. The automatic assigning system 300 employs devices in the reference block, adjacent to devices in the sub-topology blocks B₁ and B₂ to be assigned, as reference devices, in order to assign the neighboring sub-topology blocks B₁ and B₂. Concrete methods of determining reference blocks and reference devices installed at nodes of the reference block can use devices with known positions in the reference block as reference devices to perform assigning based on the aforesaid first and second embodiments or any other existing assigning methods. Preferably, the automatic assigning system 300 verifies the reference block. Concretely, in step S200, based on first reference devices in the reference block, the automatic assigning system 300 adopts a first assigning method to presume that (?) reference devices are installed at each node of the reference block respectively. Then, in step S201, the automatic assigning system 300 uses reference devices, different from the first reference devices, as second reference devices, and adopts a second assigning method to presume that (?) reference devices are (?) installed at each reference position of the reference block again. Finally, in step S202, if the presumption result corresponding to the second reference devices is identical with the result corresponding to the first reference devices, the automatic assigning system 300 determines reference devices installed at each node of the reference block according to the presumption result. It will be understood that, under the circumstances that the first reference devices are different from the second reference device, the first assigning method can be the same as or different from the above mentioned second assigning method, and both of their assigning results can serve the function of verification; likewise, the first reference devices can also be further used, and if a second assigning method different from the first assigning method is employed, the assigning result can also serve the function of verification. It will be understood that the present invention is elucidated by assuming that a reference block is also a topology block; in other embodiments, a reference block itself can also include multiple reference devices.

After determining the reference block Bᵣ, as shown in FIG. 11, in step S21, the automatic assigning system 300 takes the reference devices R₁, which are adjacent to the target sub-topology block B₁ to be assigned, of the reference block Bᵣ as initial reference devices, uses an initial assigning method to perform initial assigning, and presumes that (?) each target device is (?) installed at each node of the target sub-topology block B₁ respectively. The initial assigning method can use any assigning method of determining target devices corresponding to nodes in the topological graph, such as the above methods described in the first and the second embodiments.

Then, in step S22, the automatic assigning system 300 uses the devices R₃, different from the initial reference devices R₁ and related to the target sub-topology block B₁, as verification reference devices, employs a verification assigning method to perform verification assigning based on the verification reference devices and presumes that (?) each target device is installed at each node of the target sub-topology block B₁. The verification reference devices can be other devices of the target sub-topology block B₁ that are (?) presumed based on the initial reference device R₁ in step S21, or still other reference devices known beforehand which are adjacent to or in the target sub-topology block B₁. It will be understood that, under the circumstances that the verification reference devices are different from the aforementioned initial reference devices, the verification assigning method can be the same as or different from the aforementioned initial assigning method, and both of their assigning results can serve the function of verification; likewise, the initial reference devices can also further be used, and a verification assigning method different from the initial assigning method is employed; in this case the assigning result can also serve the function of verification.

Then, in step S23, the automatic assigning system 300 judges and verifies whether the presumption result, corresponding to the reference device R₃ and/or the verification assigning method, is identical with the presumption result corresponding to the reference device R₁ and the initial assigning method. If they are identical, then the automatic assigning system 300 judges that the target sub-topology block B₁ has been successfully assigned and doesn't need to be verified again; the sub-topology block B₁ can then be taken as a reference block to assign other neighboring sub-topology blocks to be assigned. If the presumption results are different, then the target sub-topology block B₁ remains to be assigned; this topology block may still be assigned successfully; the details will be elucidated in the following part of the description.

Irrelevant to the above steps S21 to step S23, based on the reference device R₂ adjacent to sub-topology block B₂, the system 300 presumes that (?) each target device is installed at each node in the target sub-topology block B₂ and verifies whether the assigning is successful. If B₂ is assigned successfully, then it can be taken as a reference block to assign other neighboring sub-topology blocks, such as B₃. Likewise, if B₃ is assigned successfully, since it is adjacent to the sub-topology block B₁, which under the aforesaid circumstances not assigned successfully, devices of B₃, which are adjacent to B₁, can be taken as reference devices, and assigning of B₁ will be performed again. In this way, the assigning time of B₁ is increased and the assigning success rate is improved.

For the whole topological graph, the above steps are repeated, all assigned sub-topology blocks are taken as reference blocks to assign other sub-topology blocks to be assigned. The simulation result in the following table illustrates the assigning success rate of the assigning method according to this embodiment:

TABLE 1

| assigning | assigning | assigning | assigning | Assigning |
|---|---|---|---|---|
| success | success | success | success | success |
| rate | rate of a | rate of a | rate of a | rate of a |
| of a single | topo- | topo- | topo- | topo- |
| sub- | logical | logical | logical | logical |
| topology | graph with | graph with | graph with | graph with |
| block (16 | 10 × 10 | 15 × 15 | 20 × 20 | 25 × 25 |
| nodes/sub- | blocks | blocks | blocks | blocks |
| topology | (1600 | (3600 | (6400 | (10000 |
| block) | nodes) | nodes) | nodes) | nodes) |
| 0.65 | 0.852 | 0.81275 | 0.73225 | 0.67225 |
| 0.7 | 0.93125 | 0.90425 | 0.88525 | 0.86275 |
| 0.75 | 0.97825 | 0.968 | 0.957 | 0.95 |
| 0.8 | 0.9935 | 0.9915 | 0.991 | 0.9865 |
| 0.85 | 0.9965 | 0.9965 | 0.99525 | 0.99575 |
| 0.9 | 0.99925 | 0.99975 | 0.99975 | 0.99975 |
| 0.95 | 1 | 1 | 1 | 1 |
| 1 | 1 | 1 | 1 | 1 |

As can be seen from the table, the assigning success rate of a topological graph having multiple sub-topology blocks is higher than that of single sub-topology block. This is because sub-topology blocks with assigning errors may still be assigned several times, therefore, the assigning success rate of the whole topological graph is substantially increased.

It is worth noting that in the process of repetition, the following situation may exist: all sub-topology blocks, having been assigned successfully, are taken as reference blocks to assign the neighboring sub-topology blocks to be assigned, but there are still sub-topology blocks to be assigned which cannot obtain a correct assigning result after they have been assigned based on all their neighboring reference blocks. In this case, the whole method of operation of the present invention can be repeated, the topological graph is divided into blocks, measured and assigned again. It will be understood that the reason why successful assigning of the topological graph cannot be ensured is that it cannott be guaranteed that the assigning algorithm cannot be influenced at all by the deviation of the practical communication environment and that each sub-topology block can be assigned correctly. Based on the content disclosed in this embodiment, those skilled in the art will understand that the whole method of operation of the present invention is reproducible and can be implemented repeatedly, and its repeated implementation does not depend on the randomness of the assigning of sub-topology blocks.

The automatic assigning system 300 can comprise corresponding means configured to fulfill the functions of each step respectively, for example, a block-dividing means and a reference block-determining means configured to fulfill step S20, an initial assigning means configured to fulfill step S21, a verification assigning means configured to fulfill step S22 and a judging means configured to fulfill step S23. Preferably, the reference block-determining means further comprises a third assigning means configured to fulfill step S200, and a fourth assigning means configured to fulfill step S201. These means can be realized through programmed CPU. Based on the above detailed description, those skilled in the art can design corresponding means and their working process, which is also within the scope of the appended claims of the present invention, and thus the specification will not give further details thereof.

It can be understood that an aspect of the present invention according to the above embodiments is not limited to the topological graph shown in FIG. 11, and can be applicable for other topological graphs and used in a three-dimensional environment. These are all within the scope of the appended claims of the present invention, and hence the specification will not give further details thereof.

What is claimed is:

1. A method of determining each target device's position in a topological graph, comprising the steps of:
a. establishing wireless connections between at least two reference devices and each target device, each of said reference devices' position in said topological graph is known, and said topological graph comprises position information of multiple nodes;
b. based on said wireless connections, measuring each target device's measured distance-related information with respect to said at least two reference devices, and obtaining distance reference information;
c. based on said distance reference information, determining to which position of said nodes each target device corresponds.

2. The method according to claim 1, wherein said step b further comprises the following steps:
assuming that each target device is located at the position of an assigning node in said topological graph, and obtaining each target device's assumed distance-related information with respect to said at least two reference devices, under said assumption;
for each target device, said distance reference information comprises the difference between its measured distance-related information and the assumed distance-related information for said assigning node;
said step c further comprises:
for said assigning node, selecting one target device, from one or more of said target devices, with a smaller difference between its assumed distance-related information and the measured distance-related information, as the target device corresponding to said assigning node.

3. The method according to claim 2, wherein said step c comprises:
for said assigning node, selecting the target device with the smallest difference between corresponding assumed distance-related information and measured distance-related information, as the target device corresponding to said assigning node.

4. The method according to claim 2, wherein said step c comprises:
c1. for said assigning node, determining the predefined number of multiple candidate target devices with a smaller difference between assumed distance-related information and measured distance-related information;
c2. taking each candidate target device as a first auxiliary reference device, and presuming there is one or more auxiliary target devices corresponding to one or more auxiliary reference nodes, according to said at least two reference devices and said first auxiliary reference device;
c3. for each combination of candidate target device and the one or more auxiliary target devices corresponding to said one or more auxiliary reference nodes, based on wireless connections among the candidate target devices and said at least two reference devices as well as the corresponding said one or more auxiliary target devices, measuring the candidate target device's measured distance-related information with respect to said at least two reference devices as well as the corresponding one or more auxiliary target devices, and assuming that the one or more auxiliary target devices correspond to said one or more auxiliary reference nodes, obtaining the candidate target device's assumed distance-related information with respect to said at least two reference devices as well as the corresponding one or more auxiliary target devices, under said assumption;
c4. determining a combination, from each combination, with the smallest difference between the candidate target device's measured distance-related information with respect to said at least two reference devices as well as the corresponding one or more auxiliary target devices and its assumed distance-related information thereof, and determining that the candidate target device in that combination corresponds to the target device at said assigning node.

5. The method according to claim 4, wherein, said step c2 further comprises the following steps:
c2-1: taking one of said candidate target devices as a first auxiliary reference device, and based on the wireless connection between one or more target devices nearby and at least two reference devices as well as the first auxiliary device, measuring said one or more target devices' measured distance-related information with respect to said at least two reference devices as well as the first auxiliary reference device;
c2-2: assuming that each of said target devices corresponds to one of said auxiliary reference nodes, and obtaining each target device's assumed distance-related information with respect to said at least two reference devices as well as the first auxiliary reference device, under said assumption;
c2-3: for said auxiliary reference node, determining one or more target devices, from all target devices, with a smaller difference between the assumed distance-related information and the measured distance-related information of said target devices with respect to said at least two reference devices as well as the first auxiliary reference devices, as the auxiliary target devices corresponding to said auxiliary node;
for each of said candidate target devices and each of said auxiliary reference nodes, repeating the above steps.

6. The method according to any one of claims 2 to 5, wherein said measured distance-related information and assumed distance-related information comprise a received signal strength indication RSSI and/or time of flight of radio signals between corresponding devices, said difference between assumed distance-related information and measured distance-related information comprises the vector difference between a relative assumed RSSI vector between a corresponding target device and a corresponding reference device under the assumption that a corresponding target device is at a corresponding position, and a relative measured RSSI vector therebetween, and/or the difference between assumed time of flight between a corresponding target device and a corresponding reference device, under the assumption that a corresponding target device is at a corresponding position, and measured time of flight therebetween.

7. The method according to claim 1, wherein positions of nodes in said topological graph are grid-shaped, and said step b comprises:
enumerating all candidate groups constituted by a predefined number of multiple target devices of all said target devices, and, for each said candidate group, determining a mathematical combination of the measured distance-related information of the predefined number of multiple target devices with respect to said at least two reference devices according to a predefined combination rule, and said distance reference information comprises the corresponding mathematical combinations of all the candidate groups;
said step c comprises:
c1. based on the corresponding mathematical combinations of all the candidate groups, selecting one target candidate group according to a predefined rule, and selecting a predefined number of multiple target devices of said target candidate group as selected devices corresponding to a predefined number of multiple assigning nodes neighboring said at least two reference devices;
c2. based on the measured distance-related information of said predefined number of multiple selected devices with respect to at least one of said at least two reference devices, determining to which assigning node each of said predefined number of multiple selected devices corresponds.

8. The method according to claim 7, wherein said at least two reference devices are on a same grid line and adjacent to each other, each of said target devices is on a same side of said at least two reference devices and/or on a same grid line as said at least two reference devices, said predefined number of multiple assigning nodes are adjacent to each of said reference devices on a same side, said distance-related information comprises a received signal strength indication RSSI and/or time of flight of radio signals between corresponding devices, said mathematical combinations are linear combinations of RSSI and/or time of flight of radio signals.

9. The method according to any one of claims 1 to 8, further comprising the following step:
d. taking said target devices, having been determined to correspond to said assigning nodes, as new reference devices, and repeating steps a to c, until the target devices corresponding to all nodes in said topological graph are determined.

10. A method of determining each target device's position in a topological graph, said topological graph comprising position information of multiple nodes, wherein the method comprises the steps of:
A. dividing said topological graph into a certain number of sub-topology blocks to be assigned according to a predefined rule, and determining a reference block, said reference block being adjacent to one or more of said sub-topology blocks to be assigned;
B. taking reference devices of said reference block, which are adjacent to said target sub-topology blocks to be assigned, as initial reference devices, using an initial assigning method to perform initial assigning, and presuming the presence of (?) said target devices to which each node of said target sub-topology blocks corresponds respectively;
C. using verification reference devices, different from said initial reference devices, and/or a verification assigning method, different from said initial assigning method, to perform verification assigning, and presuming the presence of said target devices to which each node of said target sub-topology blocks corresponds respectively;
D. if the presumption result of said initial assigning is identical with the presumption result of said verification assigning, then judging that said target sub-topology blocks have been assigned; if the presumption results are different, then judging that said target sub-topology blocks remain to be assigned;
E. taking all said sub-topology blocks having been commissioned as reference blocks, repeating said steps B to D in order to assign all of said sub-topology blocks to be assigned.

11. The method according to claim 10, wherein the step for determining a reference block in said step A comprises:
based on first reference devices, using a first assigning method to presume reference devices correspond to each node in said reference block respectively;
using second reference devices, different from said first reference devices, and/or a second assigning method, different from said first assigning method, to presume the presence of (?) reference devices correspond to each node in said reference block respectively;
if the presumption result, corresponding to said second reference devices and/or said second assigning method, is identical with the presumption result, corresponding to said first reference device and said first assigning method, determining reference devices corresponding to each node in said reference block respectively according to said presumption result.

12. The method according to claim 10 or 11, wherein said verification reference devices comprise target devices in said target sub-topology block, which are presumed in said step B.

13. An assigning apparatus for determining each target device's position in a topological graph, wherein said topological graph comprises position information of multiple nodes, the position of at least two reference devices in said topological graph is known, and there are wireless connections between each reference device and each of said target devices, comprising:
a receiver, configured to receive each of said target device's measured distance-related information with respect to said at least two reference devices;
a first obtaining means, configured to obtain distance reference information;
a first determining means, configured to determine to which position of said nodes each of said target devices corresponds respectively, based on said distance reference information.

14. The apparatus according to claim 13, wherein said first obtaining means is further configured to:
assume that each of said target devices is located at the position of an assigning node in said topological graph, and obtain each of said target devices' assumed distance-related information with respect to said at least two reference devices, under said assumption; wherein
for each of said target devices, said distance reference information comprises the difference between its measured distance-related information and assumed distance-related information for said assigning node;
said first determining means is further configured to select, for said assigning node, one target device, from one or more of said target devices, with a smaller difference between its assumed distance-related information and the measured distance-related information, as the target device corresponding to said assigning node.

15. The apparatus according to claim 14, wherein said first determining means comprises:
a candidate device-determining means, configured to determine, for said assigning node, a predefined number of multiple candidate target devices, with a smaller difference between assumed distance-related information and measured distance-related information;
an auxiliary target device-presuming means, configured to take each candidate target device as a first auxiliary reference device, and presume that there are (?) one or more auxiliary target devices corresponding to one or more auxiliary reference nodes, based on said at least two reference devices and said first auxiliary reference device;
a second obtaining means, configured to perform, for each combination of candidate target device and the one or more auxiliary target devices corresponding to said one or more auxiliary reference nodes, based on wireless connections between each candidate target device and said at least two reference devices as well as the corresponding one or more auxiliary target devices, a measurement of each candidate target device's measured distance-related information with respect to said at least two reference devices as well as the corresponding one or more auxiliary target devices, and assume that the one or more auxiliary target devices correspond to said one or more auxiliary reference nodes, obtain each candidate target device's assumed distance-related information with respect to said at least two reference devices as well as corresponding one or more auxiliary target devices, under said assumption;
said first determining means is further configured to:
determine a combination, from all combinations, which has the smallest difference between said candidate target device's measured distance-related information and assumed distance-related information with respect to said at least two reference devices as well as corresponding one or more auxiliary target devices, and determine that the candidate target device in that combination corresponds to the target device at said assigning node.

16. The apparatus according to claim 15, wherein said auxiliary assigning device-presuming means further comprises:
a third obtaining means, configured to take one of said candidate target devices as the first auxiliary reference device, and based on wireless connections between one or more target devices nearby and at least two reference devices as well as a first auxiliary reference device, measure said one or more target devices' measured distance-related information with respect to said at least two reference devices as well as said first auxiliary reference device;
a fourth obtaining means, configured to assume that each target device corresponds to one of said auxiliary reference nodes respectively, and obtain each target device's assumed distance-related information with respect to said at least two reference devices as well as said first auxiliary reference device, under said assumption;
a second determining means, configured to determine, for said auxiliary reference nodes, one or more target devices, from all target devices, with a smaller difference between said target devices' assumed distance-related information and the measured distance-related information with respect to said at least two reference devices as well as said first auxiliary reference device, as the auxiliary target devices corresponding to said auxiliary reference nodes.

17. The apparatus according to claim 13, wherein said topological graph is grid-shaped, and said first obtaining means is configured to:
enumerate all candidate groups constituted by a predefined number of multiple target devices of said target devices, and for each candidate group, determine a mathematical combination of the measured distance-related information of the predefined number of multiple target devices of each said candidate group, with respect to said at least two reference devices, and said distance reference information comprises the corresponding mathematical combinations of all candidate groups;
said first determining means comprises:
a candidate group-determining means, configured to select, based on corresponding mathematical combinations of all the candidate groups, one target candidate group according to a predefined rule, and selecting a predefined number of multiple target devices of said target candidate group as selected devices corresponding to a predefined number of multiple assigning devices adjacent to said at least two reference devices;
a third determining means, configured to determine, based on measured distance-related information of said predefined number of multiple selected devices with respect to at least one of said at least two reference devices, to which assigning node each of said predefined number of multiple selected devices corresponds respectively.

18. The apparatus according to claim 17, wherein said at least two reference devices are on a same grid line and adjacent to each other, each target device is on a same side of said at least two reference devices and/or on a same grid line as said at least two reference devices, said predefined number of multiple assigning nodes are adjacent to each reference device on a same side, said measured distance-related information comprises a received signal strength indication RSSI and/or time of flight of radio signals between corresponding devices, and said mathematical combinations are linear combinations of RSSI and/or time of flight of radio signals.

19. An apparatus for determining each target device's position in a topological graph, said topological graph comprising position information of multiple nodes, wherein the apparatus comprises:
a block dividing means, configured to divide said topological graph into a certain number of sub-topology blocks to be assigned, according to a predefined rule;
a reference block-determining means, configured to determine a reference block, said reference block is adjacent to one or more sub-topology blocks to be assigned;
an initial assigning means, configured to take reference devices of said reference block, which are adjacent to said target sub-topology blocks to be assigned, as initial reference devices, use an initial assigning method to perform initial assigning, and presume the presence of (?) said target devices to which each node of said target sub-topology blocks corresponds respectively;
a verification assigning means, configured to use verification reference devices, different from said initial reference devices, and/or a verification assigning method, different from said initial assigning method, to perform verification assigning, and presume the presence of (?) said target devices to which each node of said target sub-topology blocks corresponds, respectively;
a judging means, configured to judge, if the presumption result of said verification assigning is identical to the presumption result of said initial assigning, that said target sub-topology blocks have been assigned or, if the presumption results are different, that said target sub-topology blocks remain to be assigned;
said reference block-determining means is further configured to take all said sub-topology blocks having been assigned as reference blocks in order to assign all other relevant sub-topology blocks to be assigned.

20. The apparatus according to claim 19, wherein said reference block-determining means further comprises:
a third assigning means, configured to use, based on first reference devices, a first assigning method to presume the presence of reference devices corresponding to each node of said reference block respectively;
a fourth assigning means, configured to use second reference devices, different from said first reference device, and/or a second assigning method, different from said first assigning method, to presume the presence of reference devices corresponding to each node of said reference block respectively;
said reference block-determining means is further configured to determine, if the presumption result corresponding to said second reference device and/or said second assigning method is identical to that of said first reference device and said first assigning method, the reference devices corresponding to each node of said reference block according to said presumption result.

21. The apparatus according to claim 19 or 20, wherein said verification reference devices comprise target devices in said target sub-topology block presumed by said initial assigning means.
